(19) United States
(12) Patent Application Publication
(10) Pub. No.: US 2003/0171971 A1
(43) Pub. Date: Sep. 11, 2003

(54) Computer based organisation systems

(76) Inventors: Mark Lovekin, Claremont (AU); Paul Robert Edgar, Claremont (AU); Graham John Reid, East Victoria Park (AU)

Correspondence Address: Martin G Linihan, Hodgson Russ, One M & T Bank Suite 2000, Buffalo, NY, 14203-2391, US

(21) Appl. No.: 10/311,573

(22) PCT Filed: Jun. 15, 2001
(86) PCT No.: PCT/GB01/02635

(30) Foreign Application Priority Data
Jun. 15, 2000 (GB) PCT GB 00 02352

(51) Int. Cl. G06F 17/60

(52) U.S. Cl. 705/9

(57) ABSTRACT

The present invention relates to computer based organization systems and in one important example to a computer based organizing application for getting and keeping all users well organized, regardless of their individuality, job role or other distinguishing aspects. The invention has particular utility in organisation of entire teams and groups of people with daily computer access, usually in an office environment. The invention also relates to a method for improving an existing organizing application; to a computer program embodying the application or for use in carrying out the method; and to network systems for monitoring and controlling plural organizing applications.

The present invention relates to computer based organization systems and in one important example to a computer based organizing application for getting and keeping all users well organized, regardless of their individuality, job role or other distinguishing aspects. The invention has particular utility in the organisation of entire teams and groups of people with daily computer access, usually in an office environment. The invention also relates to a method for improving an existing organizing application; to a computer program embodying the application or for use in carrying out the method; and to network systems for monitoring and controlling plural organizing applications.

There are many computer based or other products available which claim to be able to help people to improve their organisational abilities. While some of the known products may work to some extent for some people, it is clear that there remain a very large number of people who are not organised. Even those people who are comparatively more organised, have rarely mastered today's mass information supply, whilst meeting increased demands and desire to perform, with greater time pressures. Additionally, it is difficult for one person to make prompt and efficient use of mass information, if those around him or her are not themselves organised.

Where there is disorganisation, whether it be of an individual, a group or a company, there is often resulting inefficiency or loss of productivity either for the individual, group or company or those working with or for them. Lack of organisation can also lead to stress and frustration.

There is a need for a solution to address the problems arising from disorganisation. The preferred solution would be one that would suit the current times and one that worked for all, regardless of their character, background, organising nature or specific job or role in life. Since most workers have daily access to a computer, it would be preferable for the solution to incorporate daily computer usage, whether in the form of a personal, portable or hand-held computer or of other apparatus such as electronic personal organisers, whether standalone or integrated with such other devices; network access devices of myriad wired or wireless forms; or still other technologies capable of providing planning functionality. For convenience, the term “computer” is here used in a general sense to encompass all such examples.

It is an object of certain aspects of the present invention to provide improved organisation applications and systems.

Accordingly, the present invention consists, in one aspect, in a network system comprising plural computer based organizing applications, each comprising a single timeline; a task/appointment entry unit for the entry of tasks and appointments on the common timeline; a timeline display for display of the timeline with relevant tasks and appointments; and a timed prompt routine which at defined regular intervals requires the user to clear each appointment in time past, with an option to create an appointment record in a archive file structure, and to clear each task in time past, with an option to enter a like task on the timeline at a selected time in the future; and a prompt routine manager which monitors for each user the timely and proper completion of prompt routines.

It has been found by the present applicants that by encouraging a user to manage tasks and applications with reference to a single timeline and by creatively monitoring compliance with defined prompt routines, a dramatic increase in organization can usually be achieved.

Preferably, wherein the prompt routine manager comprises a server prompt manager associated with a central server database and plural client prompt managers associated with respective applications.

Advantageously, wherein the client prompt manager is adapted to identify whether a network connection exists and in accordance therewith, to switch between offline and online prompt routines.

Suitably, the offline prompt routine comprises the step of storing results of the prompt routine locally; and the online prompt routine comprises the steps of updating the central server database with any prompt routine results stored locally since the last online prompt routine; generating user specific statistical data from the central server database; generating user messages selected from a set of user messages in accordance with said statistical data and storing results from the prompt routine on the central server database.

In one example of the invention, the online prompt routine further comprises the step of checking the update status of the client application and client prompt routine manager and downloading appropriate upgrades.

In a further aspect, the present invention consists in a server application for use with plural client organizing applications, each client organizing application comprising a single timeline; a task/appointment entry unit for the entry of tasks and appointments on the common timeline; a timeline display for display of the timeline with relevant tasks and appointments; and a timed prompt routine; the server application comprising a server prompt routine manager which monitors for each user the timely and proper completion of prompt routines and a server database storing for each user statistical information on user completion of prompt routines.

Advantageously, the server prompt routine manager further serves to update the server database with any prompt routine results stored locally since the last server prompt routine.

Preferably, the server prompt routine manager further serves to generate user messages selected from a set of user messages in accordance with said statistical information.

Suitably, the server prompt routine manager further serves to check the update status of the client application and to download appropriate upgrades.

In still a further aspect, the present invention consists in a computer based organizing application, comprising a single timeline; a task/appointment entry unit for the entry of tasks and appointments on the common timeline; a timeline display for display of the timeline with relevant tasks and appointments; and a timed prompt routine which at defined regular intervals requires the user to clear each appointment in time past, with an option to create an appointment record in a archive file structure and to clear each task in time past, with an option to enter a like task on the timeline at a selected time in the future.

Advantageously, wherein timely and proper completion of prompt routines is monitored and messages presented to the user in accordance with said monitoring.

Preferably, statistical information is collected concerning user completion of prompt routines.

Suitably, messages are generated through selection of appropriate messages from a set of user messages, in accordance with said statistical information.

A preferred form of the invention includes an interactive pledge routine requiring each user to agree explicitly a predefined standard of acceptable user performance in the completion of prompt routines.

Whilst attention has been focussed on tasks and appointments, the invention has broader application. The term “tapp” has been coined which is a contraction of the words “task” and “appointment” but in the context of this specification is to be regarded as any single item that is put on a list that is time based (in the sense of time and/or date based) and does not carry any history. It can represent—as examples—a task; an appointment; an email or a link to an email (in or sent) requiring future action; a reminder; an idea; or a pointer to a document or an application.

The present applicants have recognized that, in addition to providing computer based organizing applications in accordance with this invention, it will be possible to provide some functionality according to the invention by modifying, configuring or supplementing existing and perhaps commercially available computer based organizing application.

Accordingly, in yet a further aspect, the present invention consists in a method of improving a computer based organizing application, which application comprises a task management module and an appointment management module, the method comprising the steps of disabling a task management module and so modifying the appointment management module as to enable it to manage both tasks and appointments in accordance with a single timeline, which is common to both tasks and appointments.

Advantageously, the application further comprises a message handling module and the method comprises the further step of so modifying the message handling module as to enable association with the timeline of any message requiring action; and enforcing deletion or archiving of any message not requiring action.

Almost everyone with a computer has a computerised planner on it of some sort. Examples of computerised planners used below include software such as GroupWise or MS Outlook or Lotus Notes. The present invention does not require the use of a sophisticated planner and in fact it will require that the user does not use a number of key elements of the planner in order for the invention to provide optimum benefits. It is also possible to use a spreadsheet product such as MS Excel as a computerised planner. The planner may be a simple diary. On the website within a network system according to this invention, there will be a number of options available to help the user set-up the computerised planner that makes best use of the software on their system. In the event that there is nothing on the user's computer to suit the requirements, there may be an option to download or install a application as referred to above.

When the user enters the setup for the first time, he would be asked what software he will be using as his computerised planner. That information will be used to give the user appropriate instructions for setting up his particular planner. Where there is no specific set of instructions for that particular planner, one of a default set of instructions can be used (depending on the type of planner) which give a generic set of instructions for setting up the planner. By way of example, the following are typical modifications made in accordance with this invention. The “appointments” function is the only one that it used and the defaults are set up accordingly. All historical dates are to be cleared. “Reminder”, “notes” and “task” lists are not to be used and are disabled. Anything that was previously in any of these lists is transferred into the appointment list, if necessary. Under “Notify” options, or the like, the time for which the notifier message (for example telling the user that he has received email) will remain on the screen before disappearing is maximised.

Since this example of the invention requires that the user uses the computerised planer and the main document (including email) control screen as his principal tools, it is important that everything keeps pointing the user back there. Thus, if the user is away from his desk for four hours, it is important for the user to go back to those principal tools on his computer when he returns. By setting the notifier to maximum default show time, any tapps or messages or emails will still be showing when the user returns. printed out.

The “set alarm when accepted” or similar option will be deselected. Since applications according to this invetion requires the user to regularly look at his planner, there is no need for alarms. If there is a critical appointment, the user may alarm this individually.

The setting up of the settings for the computerised planner can be done here by the individual on being prompted to do the necessary steps in the website. The set of instructions given on the website can be chosen so that it relates to the type of computerised planner being set up. Alternatively, or in addition, the user can download or install software which acts to change some or all of the various settings of his computerised planner. Alternatively, or in addition, in the day to day running of the application, the administrator of the system can monitor if the set up has been effected and maintained correctly. This may be done by asking the user questions, or by determining the set up by monitoring the users computer or carrying out an inspection onsite or remotely. If not, set up correctly remedial action can be taken.

One of the most significant aspects of the computer set-up is that the computerised planner is to use only the appointments section. That is, often the planners have a notes section and a tasks section. This example of the invention requires these not to be used. The aim is to have everything on one list, not some things on a physical notepad list of things to do, not some things in the computerised task list and some things in the computerised notes list and some things in the computerised appointments list, but rather everything on one list, for example the appointments list. The ability to have more than one list is preferably disabled. This enforces the user to put each task into a time slot. Everything that will take more than about two minutes must be entered into the planner.

Within the computerised planner all tapps are either rolled over to their next logical step or deleted once they are totally dealt with and there is no follow up action. No history is to be left on the planner. For required history for say an appointment or a phone call, the user is told to make a file note and put it in the relevant file. This is much more purposeful than history that may not even have occurred being left on the planner. This is a particularly important feature. It tells the user (and any third party enforcer) that the user has appropriately dealt with the next step before transferring or deleting the entry. If the user wishes to keep other history (non-specific) then he is told to do so as he clears it from the planner by putting it in a diary or in a specific history file or time sheet type document (using the computer preferably, for example using MS Word or Excel or some other means). The user is told that the best history is that which is appropriately detailed and kept in the specific relevant file. As part of set-up the user must delete all previous history on the planner (in the event that he was previously using the planner) for at least the previous month.

Preferred features of the present invention will now be described, purely by way of example, having reference to the accompanying drawings, of which:

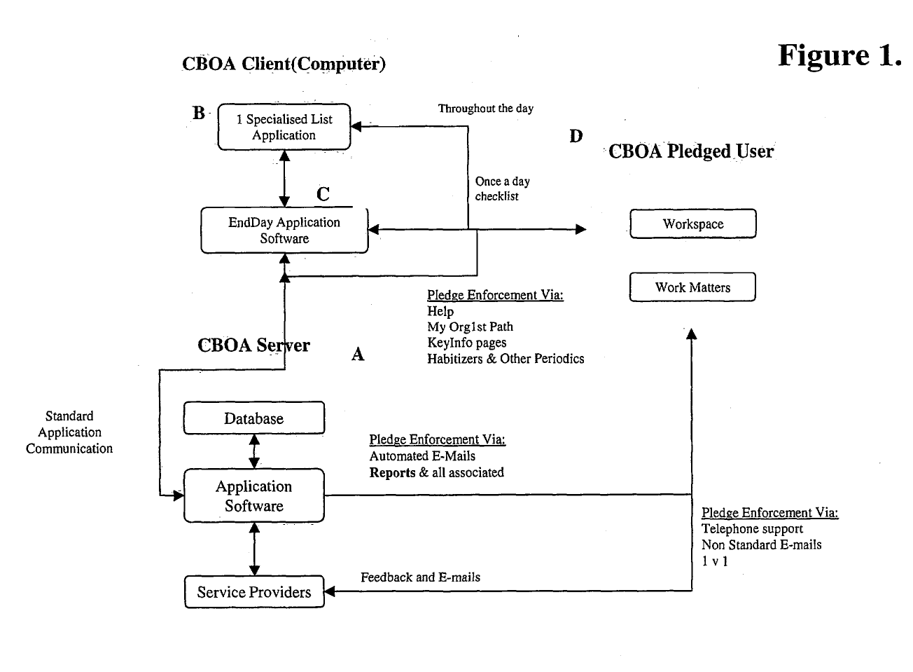

FIG. 1 shows a schematic overview of one example of the present invention;

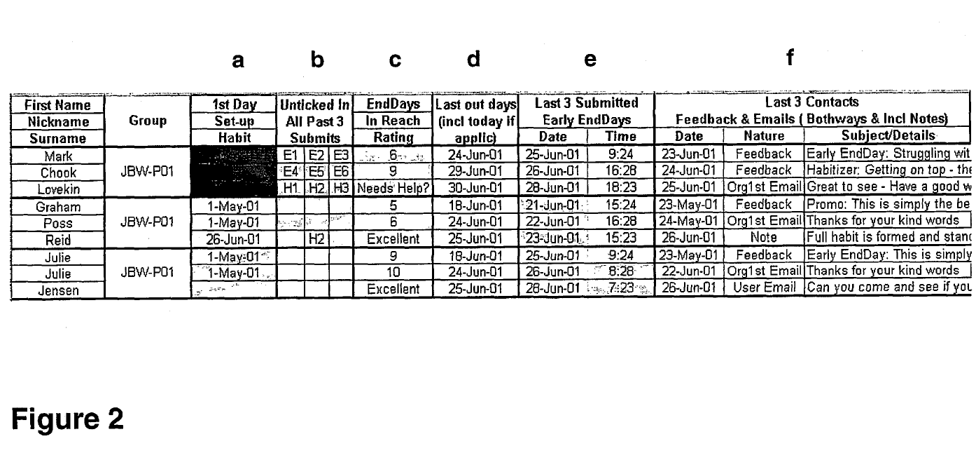

FIG. 2 is a representative screen print from a report generated in this example;

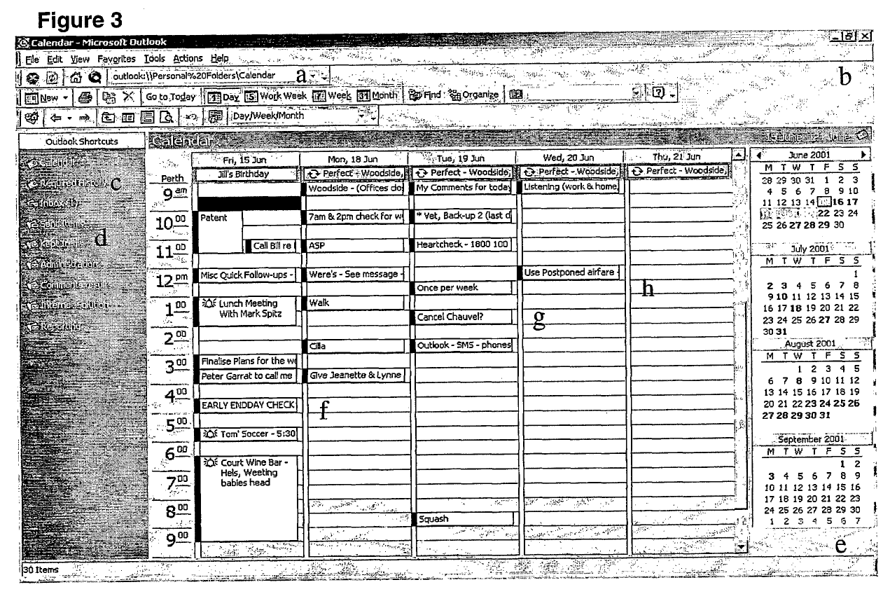

FIG. 3 is a representative screen print from a planner in this example;

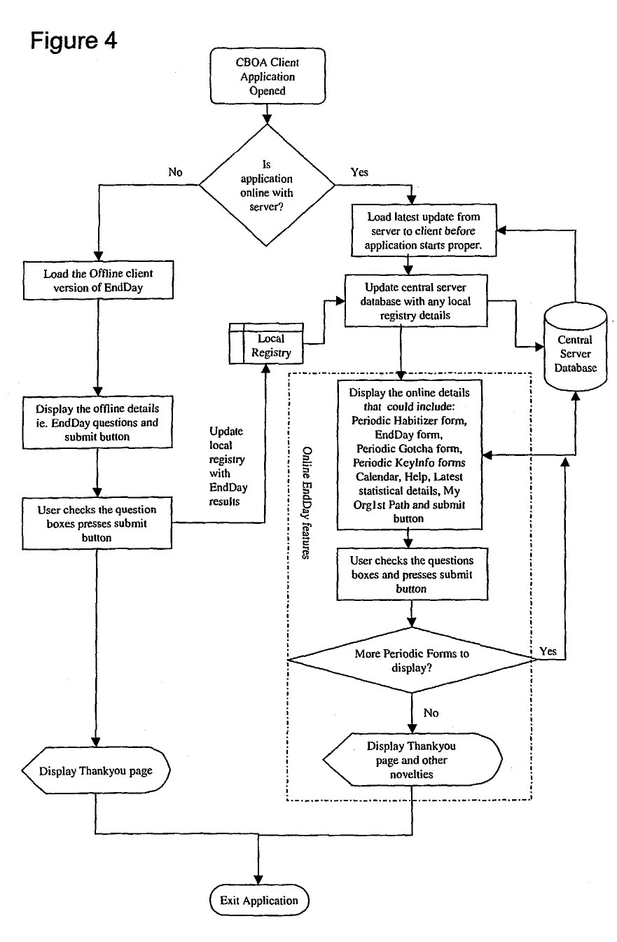

FIG. 4 is a flow chart illustrating an application from this example;

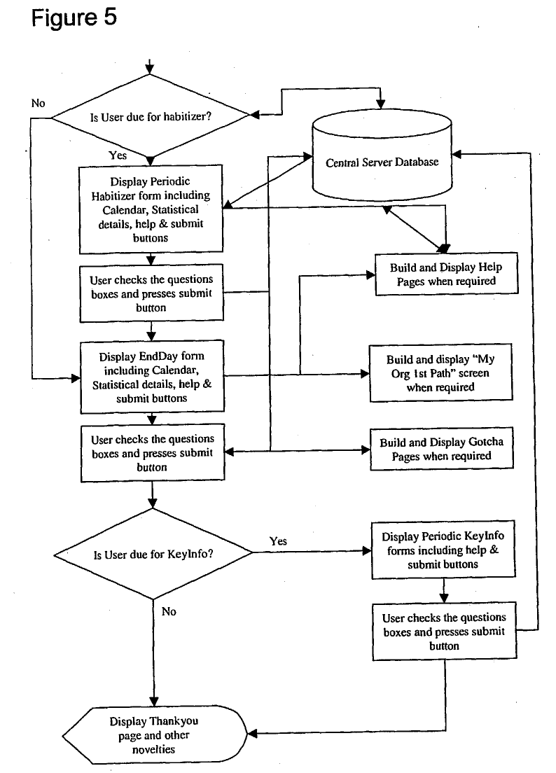

FIG. 5 is a flow chart showing in greater detail that portion of FIG. 4 which is shown within the dotted outline; and

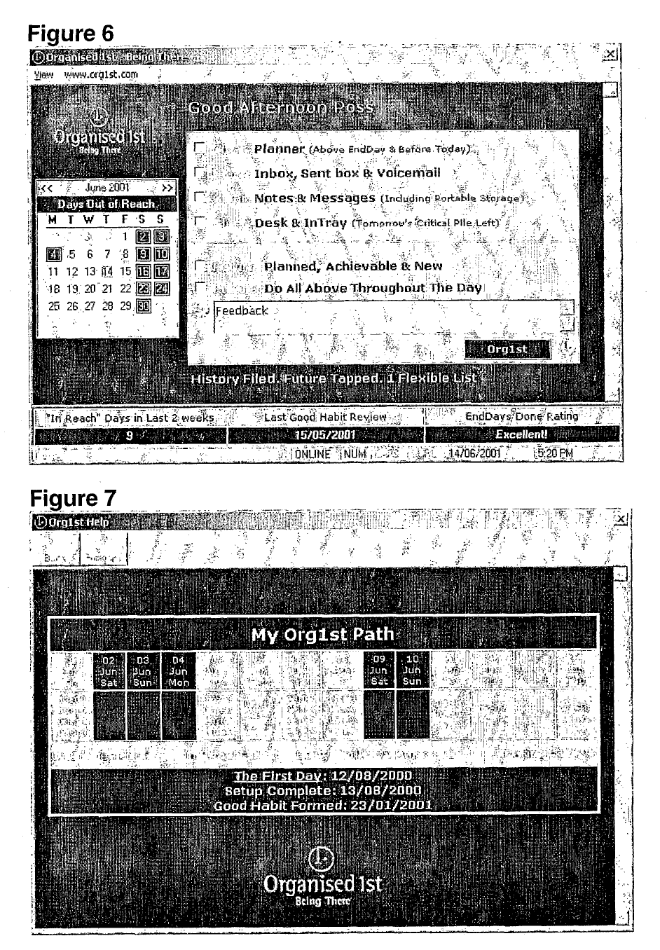

FIGS. 6 to 13 are further, representative screen prints from the example.

Referring initially to FIG. 1, there is shown in diagrammatic form an overview of a Computer Based Organizing Application (CBOA) according to certain aspects of the invention. The purpose of the application is to ensure that a user gets well organised and stays well organised. Principally there is computer hardware and software involved both at the user's end and at the provider's end. The application ultimately enforces a user to work efficiently and effectively and from one specialised list throughout a day resulting with the users being on top of all matters of any nature that concern them as they are centred on that one specialist list and are only of future origin. All history is properly dealt with and the user is geared for accelerated improvement in all job and life aspects.

The various elements of the CBOA shown in FIG. 1 will now be listed with a brief description of their respective functions. Detailed description will then follow, element by element.

The CBOA Server & Service Providers shown collectively at A, comprise a remote computer server, the application, a database and the service providers which function collectively to control the entire CBOA. These functions include set-up, use, monitoring and reporting, together with a range of feedback and other activities which are referred to as “enforcement”.

There is resident on each CBOA Client Computer a “1 Specialised List” application, shown at B, which together with a local database provides task, appointment and other functionality according to a common timeline or single list. This application may also be referred to in this specification as the planner. Also on each CBOA Client Computer is a so-called “EndDay” Application, shown at C, which with its associated database operates in conjunction with the server, its application & database in the various enforcement and other activities.

The subscribing or “Pledged” user and their work environment are illustrated at D. This work environment will principally consist in other applications running on the Client Computer.

Turning now in more detail to the CBOA Server & Service Providers shown collectively at A, the user is first set-up on the server database. The Server then stores additional relevant data on the database and utilises the associated application to communicate at a number of different levels directly and indirectly (usually via the internet), including daily through the CBOA EndDay application that is stored on the users computer. The Server application is used to run a report either automatically or upon request from the provider or a manager of the user. This report (see FIG. 2) then forms the basis of all other enforcement action necessary to ensure that the user makes full and effective use of the CBOA in its entirety and in particular ensures they work well from the planner throughout each day.

Most of the issues within the system of FIG. 1 that have “Pledge Enforcement” underlined, involve this report to some extent. The information for this report is principally compiled through “EndDay” submissions carried out by the user and submitted to the server.

Turning now to FIG. 2, the report will be described utilizing the lettered (a to f) columns in the screen print. Thus in column a, the “1^{st} Day” is the day that the user first had the total CBOA elements presented to them and they pledged their support. The “Set-up” is the day the user was set-up with all necessary in a manner that allowed them to be CBOA operational. This is usually within a couple of days of the 1^{st} Day. The “Habit” is filled in with a date when the user has reached a level that means they are habitually in a well organised state throughout each day. This report contains some shadings within the boxes to identify that assistance or enforcement is required for a user to be in a good CBOA state. The darker the shading, the more urgent the attention required. For example, “Mark Chook Lovekin” is shaded dark in this column. The “1^{st} Day” date is considerably in the past and there is not yet a Set-up date.

Column b identifies when a user has consistently not checked certain boxes within a “Habitizer” or “EndDay” form. Assistance or enforcement action is then enabled.

“EndDays” in column c signifies the number of “EndDay” forms (or, more simply, “EndDays”) submitted in the last two weeks. “In Reach” identifies the number of days that the user was within reach of their computer for more than one hour over the last two weeks. The “Rating” is first calculated as a percentage of “EndDays” submitted against the number of days “In Reach”. Generally, if this is equal to 80% or above, then the word “Excellent” is placed in this field. If the percentage is less than 80%, then the words “Needs Help” are placed here, which generally means that the user requires help with CBOA aspects or help with their job. They will then receive this help or—if it is simply a lack of discipline issue —enforcement.

Column d is used by the user's manger or the CBOA provider to assess actions required.

Column e gives the last 3 dates and times that the “EndDay” was submitted, utilising the time on the user's local computer that is submitted to the server as part of the “EndDay” Application procedure. This is also useful for follow-up purposes.

On almost every CBOA form that is presented to the user to be checked, there are feedback boxes for queries and miscellaneous comments. In addition, when emails or other interaction happens between the server or the CBOA provider and the user, this recent communication is shown on this report in these columns.

The Service Providers ensure that the user is first set-up within administration. A report screen can be provided to show “Habitizer” frequency data necessary to ensure that the “Habitizer” is periodically displayed in accordance to the users level of familiarity with CBOA. Another screen shows a simple list of users alphabetically listed by unique email address; the CBOA provider can edit individuals data from here. Further screens provide new or standard periodic forms to assist an individual or group of users with certain CBOA key aspects. There are course many other reporting options within administration.

The importance of the “1 Specialized List Application” at B of FIG. 1 will now be discussed.

Currently people work from various forms of lists which essentially make it difficult to stay well organized. Priorities become difficult to juggle in this era of high demands, information overload and interruptions. The present invention affords considerable advantage through providing a single date and time based list, on which all important matters are contained. Moreover, the application prevents this list from accumulating history. In this way, the invention enables the user to stay on top of issues and improve thereafter at a fast rate.

The settings of some current lists and associated software allow modifications that make them useful in accordance with the present invention. Thus one aspect of the present invention consists in a software or other method for modifying an existing organizing application. In another aspect, a dedicated planner is provided, offering a fuller range of functionality in accordance with the present invention.

Reference is now made to FIG. 3, which is a screen shot from a commercially available application, “Microsoft Outlook”, which has been configured and enhanced in accordance with the invention. These enhancements, more fully described below, are of course only examples and it will be possible similarly to modify other applications, commercially available now or in the future. Describing key application features by reference to modification of a well known application, also represents a convenient method of providing a disclosure of a planner in accordance with the invention.

For clarity, the following paragraphs refer respectively to lettered regions (a to h) of the screenshot which is FIG. 3.

a. The current “Work Week” toolbar option and accompanying view starts at a set day each time. This planner will have a “Next 5 Work Days” option that will display at the push of one button the view that is seen from Friday 15 Jun. to Thursday 21 Jun. with today being 15 Jun. Similarly a “Next 7 Days” view option is to be included that would display all the calendar days for the next 7 days. This is to be unlike the current “Week” button in functionality within MS Outlook 2000 and more like the current “Work Week” functionality.

b. Upon closing the application down, any tasks, appointments, notes, reminders or other tapps that are tapped up on the planner and are now in a historical timeslot are to be highlighted by the shut down process that will disable complete shutting down until these are appropriately dealt with in the CBOA manner. In relation to this process, that is they are deleted or stored somewhere off the main list or transferred to a realistic time and date of likely action. The application will do similar with the master inbox and sent box email boxes upon closing down of the planner. That is, if the prime Inbox & Sent box have emails that are past say 12 hours old then they need to be deleted, appropriately stored for later reference or linked or converted to a tapp on a realistic time and date of likely action. That is they must be cleared. The application will also insist on similar processes for the master inbox and sent box email boxes and tapps when they have effectively been of historical nature but in a present and future storage area for a period of say 1 business day past from the current time.

c. A Required History Folder will come as standard with the planner application for storing relevant tapp history. This will be similar in operation to the prime calendar but will be designed to look significantly different by default so prevent confusion between the two. This Required History Folder will only store historical items, whilst the main calendar, the planner, will only have the future in it. The action of clearing the planner as a user works throughout a day, ensures that future action is in the right place, that history is in the right place (often in the computer trash.

d. Similar to Required History, an Emails Kept Folder can be used for those emails that the user is not quite ready to delete and don't have a home in a specific folder. This relates to In & Sent Email and should be a standard part of the application and with appropriate headings. The action of taking them out of the main inbox for example as soon as possible to when they arrived, clears mental congestion and stops the inbox being another list and ensures action is appropriately tapped up into the future if necessary.

e. No task, notes, reminders or any other form of list will be allowed to form part of the screen that presents the planner.

f. There will be a facility to set up some tapps with additional security features to reduce the risk of them being deleted by accident and possibly not permitting deletion without express authorisation or at all. “EndDay” will be one such standard Tapp. There will be a facility to move the tapp further into the future. The “EndDay” Application will bring up the “EndDay” form automatically if the “EndDay” Tapp is past 1 hour of the current time. It will continue to so periodically until it is carried out. The “Enday” application will also work in conjunction with the planner application to bring up the “EndDay” form if the “EndDay” has not been done in the last two “in Reach” Days.

g. This planner application will pop up a query if a Tapp is dragged say more than five times without any adjustments. This facility can be switched off for selective tapps.

h. As a standard, alarms will not be on the tapps when a user creates a tapp. A user will still be able to put the alarm on, but it is should rarely be needed if a user is well organised and constantly looking and working from the planner.

Reference is now directed to the “EndDay” Application shown in FIG. 1 at C and resident on the client computer. This client application is designed as the interface to the CBOA Server. It will be described with reference, initially, to FIG. 4.

For installation, a set-up executable file is sent to all users and the software is installed using the standard installation routine supplied by Windows. The software can reside on the local c:drive or on a network drive as stipulated by the system administrator. The application is then available to run.

Once the client application is installed it can be opened by 1 of three methods:

Clicking on the Org1st logo on the Start bar

Clicking on the Org1st logo on the desktop

Clicking on the Org1st.exe file in the appropriate directory on the C: Drive.

The first time the client application is run it invokes an options screen having a “General” tab under which the user's First Name, Last Name, Nick Name, Password and E-mail addresses must be entered. This will determine if the user has access to the CBOA server. A second, “Email” tab on the options screen prompts entry of the mail server (SMTP) name and port number that this PC will use to contact SMTP to the CBOA server. This isagreed with the network administrator before installation.

Once opened the application then determines if the CBOA server is contactable and it can open up a reliable line of communication (see FIG. 4). If it is, then the application will run in the Online mode. Otherwise, unless a reliable connection with the server is achieved within a given time frame (this varies from user site to user site) it will run in the offline mode.

In the offline mode the application is very simple and will display only the “EndDay” form (see below) including all the questions and the submit button but not the Calendar, Help, or Statistical data.

In the online mode the first step for the application is to contact the server to see if there are available updates. It achieves this by matching a file called “Updates.txt” stored in the appropriate directory on the client to the same file held on the server. If the serial numbers match then a message “No updates were necessary” is generated. If the serial numbers do not match, then each file is matched for date and time stamps differences. If they appear in the “before” section of the file they will be updated now. These will typically be smaller files taking up less time to load whilst the user is waiting. If they appear in the “after” section of the file they will be updated after the application is closed.

The next task the application performs is updating the central server database with any local registry details that may have changed since last “online”. The application checks the appropriate directory to see if any “EndDay”s have been submitted offline. If so, then it will submit this data to the server before the application is opened in the full sense. In this way, integrity of the database is ensured, before any of the statistical details are displayed on the screen.

The Main Client Application Screen is shown at FIG. 6. There are some common items displayed on the Main Client Application Screen no matter what specific form is co-displayed. On the left hand side of the application screen is a calendar. This calendar is used to record the user's “Days Out of Reach”. The following points are worthy of note:

Future “Days Out of Reach” are to be marked prior to being so.

Unexpected “Days Out of Reach” are to be marked upon return.

As a guideline; in excess of 1 hour with computer access is to be regarded as “In Reach'

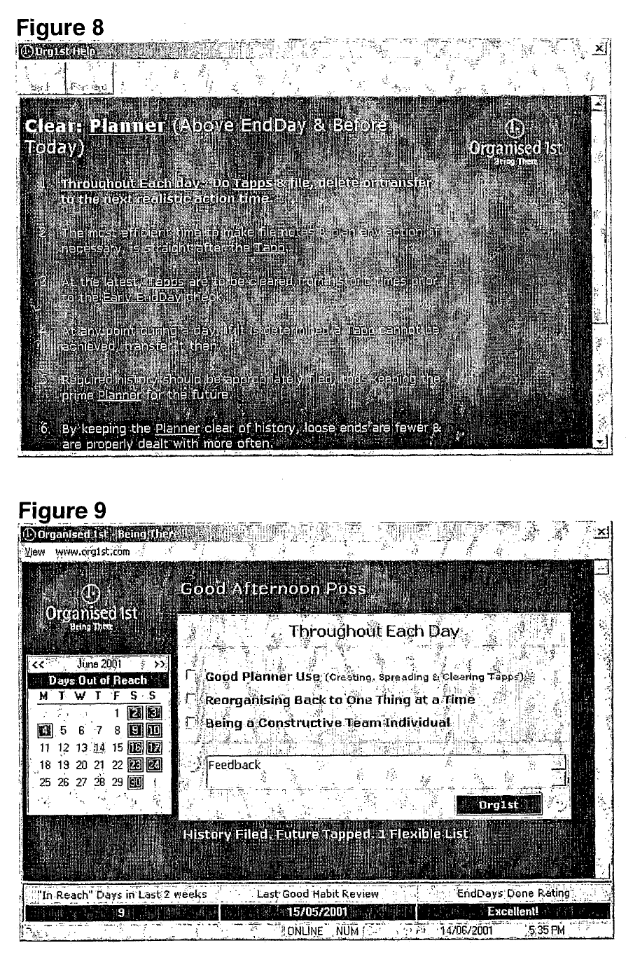

Throughout the client application, help screens are available. The application is designed such that holding the mouse cursor over any area of the screen that has help attached, causes the arrow cursor to changes into a hand which can then be clicked to access a help screen. An example of such a help screen is given In FIG. 8. Within the help screens are appropriate hyperlinks to other help screens and to glossary terms. Navigate through the help screens is easily achieved using the “forward” and “back” buttons in the top left of the Help Screen.

Along the bottom of the screen of FIG. 6 is a Statistical Bar comprising three boxes. The box at the left hand side shows “In Reach Days in Last 2 Weeks. This figure is calculated from the “Days Out Of Reach” calendar. In the various review and monitoring processes, the figure can be compared with the total number of working days, and appropriate feedback given to the user to instill good working practices. Clicking on the number within the box will take the user to one to the “My Org1st Path” screen show in FIG. 7.

The middle box in the Statistical Bar represents the “Last Good Habit Review date”. This date is entered upon the user reaching full good habit level as reviewed by an service provider specialist and is updated upon subsequent good habit reviews. Clicking on the date within the box will again take the user to the screen shown in FIG. 7. This screen is used by the user to view their own specific “EndDay” submission history. This will also be used as a basis for Team Leaders, Managers and CBOA service providers to provide feedback as to the User's progress towards honouring their pledge.

The right hand box of the Statistical Bar is titled “EndDay Done Rating” and contains a figure calculated as follows: “EndDay” Done Rating=No of “EndDay” submissions received by the CBOA Server over the last 14 days/No of In Reach Days over the last 14 days ×100 to give a percentage. Based on this percentage the “EndDay Done Rating” is calculated using a parameter table set-up on the server database.

The next step (see FIG. 5) that the online application takes is to checks the “members” table on the database to see if the “Habitizer” is due for this user. This causes the main application screen including the Habitizer form (see FIG. 9) to be displayed for that user. In simple terms, the Habitizer will be displayed from time to time, the frequency of which can be set in the admininistration section of the CBOA server application.

The user is instructed that the checklist should be filled out honestly and where the boxes cannot honestly be checked then they are left unchecked. There are three main points in the Habitizer, that the user is instructed to keep in mind and to ask themselves whether they are being completed each day. The bullet points below each item explain by way of background the detailed instructions which may be given to a typical user in training and in feedback.

“Good planner use”

On the Planner, Tapps need to be logically & regularly created, spread & cleared.

This helps to foster the 1 Flexible List methodology. Issues are more easily & efficiently dealt with.

Everything (physical & computerised) is to be done & filed, with outstanding issues Tapped Up.

Tapps are to be spread across the future in realistic action times and allowing for a reasonable degree of interruptions. Excessive interruptions need a Reorganisation.

Time for a Tapp should be overestimated rather than underestimated.

Tapps are to be Priority Aligned.

1 list on the Planner is more manageable and Flexible than having things to do on a paper list & in the inbox mixed up with non-issues & on loose bits of paper & in a physical diary etc.

One is to learn from history and then clear or store it to make room for the future.

“Re-organising back to one thing at a time”

The best work is done one thing at a time. We need to often Reorganise back to this.

The “Interruption Era” constantly drags us away from this.

Making time to regular reorganise keeps one efficiently & effectively on top.

If e-mails can't be efficiently dealt with immediately & they build up, then use a break to clear them.

Try to do key Early “EndDay” aspects Throughout Each Day.

Clear Planner, Clear Main In & Sent Box, Clear Notes, Clear Desk & In Tray.

Reorganise back to 1 Flexible List

“Being a Constructive Team Individual”

As the foundation, strive to do ALL aspects of Org1st, well.

Logically, this will be used as the foundation to collectively thrive thereafter.

Do what is necessary to be one of the ones fostering positive change.

Being a Constructive Team Individual means to do combine all aspects:

Constructive: Serving to help, improve or advance the team.

Team: A group on the same side, organised to work respectfully together (Society, family, companyy)

Individual: The uniqueness that is valued by the team. (Qualities, creativity, character, experience)

The user must then click on the “Org1st” button below the checklist to submit the answers and feedback to the CBOA server. These answers form the basis of the statistical data for subsequent display at the bottom of the screen.

The next step in the application is to display the “EndDay” form (see FIG. 6). This view is the most predominant view the user sees of the application. The user is instructed that the checklist should be filled out honestly and where the boxes cannot honestly be checked then they are to be left unchecked. There are six main points in the “EndDay”, that the user must keep in mind and ask themselves whether they performed these tasks today. Through performing the six main “EndDay” points each day, the user is encouraged to work daily from one planner. The bullet points below each of the screen items listed below, explain by way of background the detailed instructions which may be given to a typical user in training and in feedback.

“Clear Planner”

Throughout Each day: Do Tapps & file, delete or transfer to the next realistic action time.

The Tapps within an historical time slot are to be appropriately dealt with through deletion or by storing them somewhere else off the main list for later reference only.

The most efficient time to make file notes & plan any action, if necessary, is straight after the Tapp.

At the latest, Tapps are to be cleared from historic times prior to the Early “EndDay” check.

At any point during a day, if it is determined a Tapp cannot be achieved, transfer it then. Transfer it to a realistic time and date for likely action.

Required history should be appropriately filed, thus keeping the prime Planner for the future.

By keeping the Planner clear of history, loose ends are fewer & are properly dealt with more often.

This is a key Early “EndDay” aspect. It keeps the team on top & stops the cracks from reappearing.

Performing Org1st aspects proficiently minimises stress overall & makes Priority Alignment is easier.

Clearing the planner forces all things requiring action to be on one specialised list in the future.

“Clear Inbox, Sent Box & Voicemail”

Throughout Each day: Deal with or delete, file & Tapp Up to the next realistic action time.

The most efficient time to do so is straight away upon receiving or sending.

At the latest, these are to be cleared prior to the Early “EndDay” check.

Within a day, when it's determined that an email can't be dealt with today, file & Tapp up then.

Required emails should be appropriately filed, thus keeping the prime boxes for the future.

Clearing Inbox, Sent Box and Voicemail forces all things requiring action to be on one specialised list.

“Clear Notes and Messages”

Throughout Each day: Deal with or delete, file or Tapp Up to the next realistic action time.

The most efficient time to do so is straight away.

At the latest, these are to be cleared prior to the Early “EndDay” check.

Within a day, when it's determined that say a note can't be dealt with today, file & Tapp up then.

Portable storage includes a meeting folder, briefcase, purse or wallet (dockets).

Required notes should be appropriately filed, thus keeping everything clear for the future.

Clearing notes and messages and Tapping them up forces all things requiring action to be on one specialised list

“Clear Desk & In Tray”

Throughout Each day: Deal with or delete, file or Tapp Up to the next realistic action time.

The most efficient time to do so is straight away.

At the latest, these are to be cleared prior to the Early “EndDay” check.

Re: Tomorrow's critical pile left. At the time of Early “EndDay”, there is to be no paperwork on the desk except for those 1-Offs that are really critical to be done tomorrow. Hopefully this is Nil due to nothing being that critical, that there aren't that many genuine 1-Offs, or they are already done. Perhaps do them after Early “EndDay” if they do exist, so as to work from 1 Flexible List tomorrow.

Within a day, when it's determined that something can't be dealt with today, file & Tapp up then.

Required paper should be appropriately filed and Tapped up if required, thus keeping everything clear for the future.

The ThisMonth and the NextMonth files can be used for things that don't have a specific home.

By keeping things clear & utilising Tapps, loose ends are properly dealt with more often.

A short note to ring someone is better Tapped Up on 1 Flexible List if it can't be done immediately.

“Future: Planned, Achievable & New”

Aim for Early “EndDay” before last lengthy Tapp/s & at least ½hr before leaving.

Prior to Early “EndDay, if not before, tomorrow's Tapps are to be reviewed and adjusted accordingly with regard to the “interruption era”, the necessity to spread & one's Priorities.

If on top of Org1st issues during the day then perhaps time after a brief Early “EndDay” could be used to be creative, to do some of tomorrow's critical paperwork or Tapps, or to go home on time.

Things are more easily managed and Flexible on the 1 List, on the Planner-Spread.

After a tough day or two it is recommended to only put really critical Tapps on tomorrow in order to give one time to get on top and perhaps be creative.

If no PDA (electronic personal data assistant) then perhaps print a copy of the planner for use until back at the computer next.

“Future: Do All Above Throughout the Day”

The most efficient way to do things that matter is: Well, once, one at a time & ASAP.

Org1st aspects are likewise best performed in this above manner & throughout each day.

There is then less time remembering and juggling & more time to be a Constructive Team Individual.

At the bottom of the “EndDay” is a resultant statement that should represent the status of every user as they complete “EndDay”. The user must then click on the Org1st button below the checklist to submit the answers and feedback to the CBOA server. These answers form the basis of the statistical data for subsequent display at the bottom of the screen.

Occasionally, at the discretion of the HBOA service providers and changeable for each user, a “Gotcha” screen will be displayed should a user answer a predetermined nonsensical question. This screen is designed to stop users checking the boxes without reading the questions.

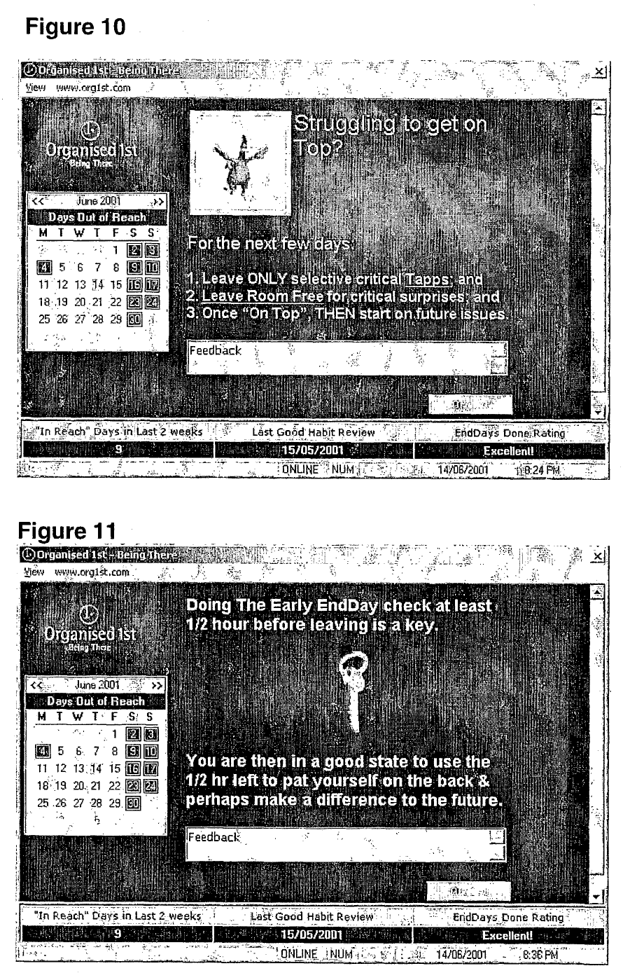

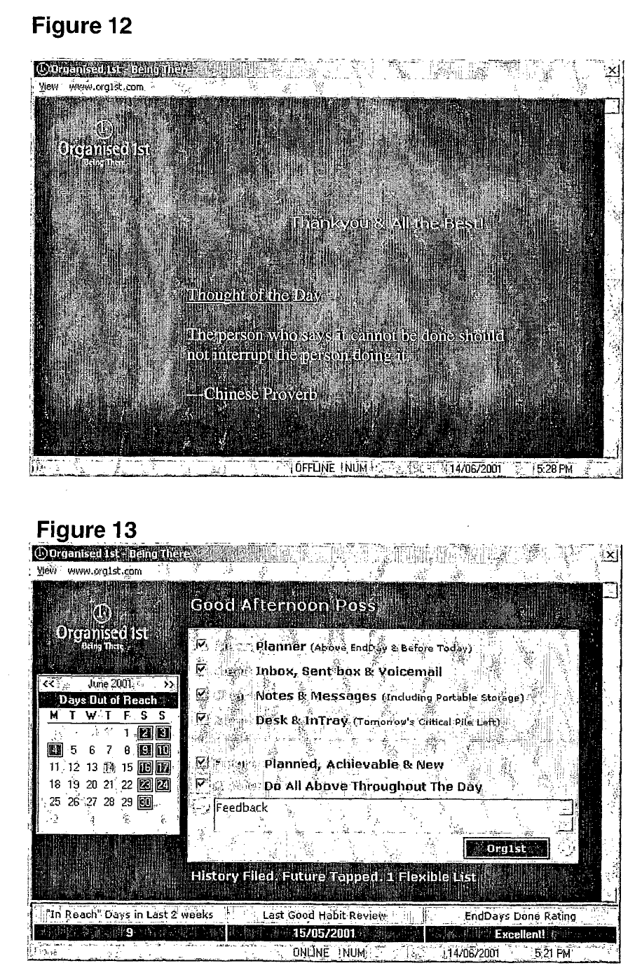

After submission, a “seenpromo” flag on the CBOA server is checked to see if the “Keyinfo” screen has been displayed for this user. If it has, then the user is taken direct to the “Thankyou” page. (FIG. 12). If the “Keylnfo” screen is to be displayed it will be displayed then. Examples of “Keylnfo” pages are contained in FIGS. 10 and 11. These screens may sometimes contain questions that require user input. At the end of each form the user clicks on the “Org1st” button to proceed. After submission of the “Keyinfo screen the “Thankyou” page will be displayed.

It should be understood that this invention has been described by way of examples only and many further modifications and variations are possible without departing from the scope of the invention.

1. A network system comprising plural computer based organizing applications, each comprising a single timeline; a task/appointment entry unit for the entry of tasks and appointments on the common timeline; a timeline display for display of the timeline with relevant tasks and appointments; and a timed prompt routine which at defined regular intervals requires the user to clear each appointment in time past, with an option to create an appointment record in a archive file structure, and to clear each task in time past, with an option to enter a like task on the timeline at a selected time in the future; and a prompt routine manager which monitors for each user the timely and proper completion of prompt routines.

2. A system according to claim 1, wherein the prompt routine manager comprises a server prompt manager associated with a central server database and plural client prompt managers associated with respective applications.

3. A system according to claim 2, wherein the client prompt manager is adapted to identify whether a network connection exists and in accordance therewith, to switch between offline and online prompt routines.

4. A system according to claim 3, wherein the offline prompt routine comprises the step of storing results of the prompt routine locally.

5. A system according to claim 4, wherein the online prompt routine comprises the steps of updating the central server database with any prompt routine results stored locally since the last online prompt routine; generating user specific statistical data from the central server database; generating user messages selected from a set of user messages in accordance with said statistical data and storing results from the prompt routine on the central server database.

6. A system according to claim 4 or claim 5, wherein the online prompt routine further comprises the step of checking the update status of the client application and client prompt routine manager and downloading appropriate upgrades.

7. A server application for use with plural client organizing applications, each client organizing application comprising a single timeline; a task/appointment entry unit for the entry of tasks and appointments on the common timeline; a timeline display for display of the timeline with relevant tasks and appointments; and a timed prompt routine; the server application comprising a server prompt routine manager which monitors for each user the timely and proper completion of prompt routines and a server database storing for each user statistical information on user completion of prompt routines.

8. A server application according to claim 7, wherein the server prompt routine manager further serves to update the server database with any prompt routine results stored locally since the last. server prompt routine.

9. A server application according to claim 7 or claim 8, wherein the server prompt routine manager further serves to generate user messages selected from a set of user messages in accordance with said statistical information.

10. A server application according to any one of claims 7 to 9, wherein the server prompt routine manager further serves to check the update status of the client application and to download appropriate upgrades.

11. A computer based organizing application, comprising a single timeline; a task/appointment entry unit for the entry of tasks and appointments on the common timeline; a timeline display for display of the timeline with relevant tasks and appointments; and a timed prompt routine which at defined regular intervals requires the user to clear each appointment in time past, with an option to create an appointment record in a archive file structure and to clear each task in time past, with an option to enter a like task on the timeline at a selected time in the future.

12. An application according to claim 11, wherein timely and proper completion of prompt routines is monitored and messages presented to the user in accordance with said monitoring.

13. An application according to claim 12, wherein statistical information is collected concerning user completion of prompt routines.

14. An application according to claim 13, wherein messages are generated through selection of appropriate messages from a set of user messages, in accordance with said statistical information.

15. An application according to any one of claims 11 to 14, comprising an interactive pledge routine requiring each user to agree explicitly a predefined standard of acceptable user performance in the completion of prompt routines.

16. An application according to any one of claims 11 to 15, wherein said task/appointment entry unit is further adapted for the entry on the common timeline of a link to a message; said timeline display is further adapted for display of said link; and said timed prompt routine serves at defined regular intervals to requires the user to clear each link in time past.

17. An application according to any one of claims 11 to 16, wherein said task/appointment entry unit is further adapted for the entry on the common timeline of a reminder; said timeline display is further adapted for display of said reminder; and said timed prompt routine serves at defined regular intervals to requires the user to clear each reminder in time past.

18. An application according to any one of claims 11 to 17, wherein said task/appointment entry unit is further adapted for the entry on the common timeline of a pointer to a file or application; said timeline display is further adapted for display of said pointer; and said timed prompt routine serves at defined regular intervals to requires the user to clear each pointer in time past.

19. A method of improving a computer based organizing application, which application comprises a task management module and an appointment management module, the method comprising the steps of disabling a task management module and so modifying the appointment management module as to enable it to manage both tasks and appointments in accordance with a single timeline, which is common to both tasks and appointments.

20. A method according to claim 19, wherein the application further comprises a message handling module and the method comprises the further step of so modifying the message handling module as to enable association with the timeline of any message requiring action; and enforcing deletion or archiving of any message not requiring action.
